(19) United States
(12) Patent Application Publication
(10) Pub. No.: US 2010/0151912 A1
(43) Pub. Date: Jun. 17, 2010

(54) Electronic Device

(75) Inventor: Pao-Tung Weng, Taipei (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: ASUSTeK Computer Inc., Taipei (TW)

(21) Appl. No.: 12/629,241

(22) Filed: Dec. 2, 2009

(30) Foreign Application Priority Data
Dec. 12, 2008 (TW) 97148617

(51) Int. Cl. H04M 1/00

(52) U.S. Cl. 455/566; 455/575.4

(57) ABSTRACT

An electronic device including a first body, a second body, an elastic component and a flexible cable is provided. The first body has a first protrusion and a hole penetrating the first protrusion. The second body is connected to the first body along the direction of a sliding path. The elastic component is disposed between the first body and the second body and has a first fixing portion and a second fixing portion. The first fixing portion is fixed on the first protrusion. The second fixing portion is fixed on the surface of the second body towards the first body. The flexible cable located between the first body and the second body has a first connecting end and a second connecting end. The first connecting end passes through the hole and is electrically connected to the first body. The second connecting end is electrically connected to the second body.

### BACKGROUND OF THE INVENTION

This application claims the benefit of Taiwan application Serial No. 97148617, filed Dec. 12, 2008, the subject matter of which is incorporated herein by reference.

### FIELD OF THE INVENTION

The invention relates to an electronic device and, more particularly, to an electronic device having two opposite sliding bodies.

### DESCRIPTION OF THE RELATED ART

In an electronic device, it is more and more common to increase the elasticity of disposing components via the movements of the two bodies. To take the sliding electronic device as an example, the movements of the two bodies of the sliding electronic device are achieved by the cooperation of multiple spring leaves or compression springs.

However, since the movements of the spring leaves and the compression springs are complex, a cable disposed between the two bodies for transmitting data is easy to be drawn, tangled and even broken by the spring leaves or the compression springs to make the electronic device unable to be used. Furthermore, the spring leaves or the compression springs also may be damaged, and the sliding of the two bodies of the electronic device is affected.

### BRIEF SUMMARY OF THE INVENTION

The invention relates to an electronic device. In the electronic device, a simple mechanism drives a body to slide, and a flexible cable may avoid being drawn or tangled by other element effectively. Thus, the quality of the electronic device in the invention increases, and the lifespan is prolonged.

According to the invention, an electronic device is provided. The electronic device includes a first body, a second body, an elastic component and a flexible cable. The first body has a first protrusion and a hole which penetrates the first protrusion. The second body is connected to the first body along the direction of a sliding path. The elastic component is disposed between the first body and the second body and has a first fixing portion and a second fixing portion. The first fixing portion is fixed on the first protrusion, and the second fixing portion is fixed on the surface of the second body towards the first body. The flexible cable is located between the first body and the second body and has a first connecting end and a second connecting end. The first connecting end passes through the hole and is electrically connected to the first body. The second connecting end is electrically connected to the second body.

These and other features, aspects and advantages of the present invention will become better understood with regard to the following description, appended claims, and accompanying drawings.

### BRIEF DESCRIPTION OF THE DRAWINGS

FIG. 1A is an exploded diagram showing the electronic device according to a preferable embodiment of the invention;

FIG. 1B is an assembly diagram showing the electronic device in FIG. 1A;

FIG. 1C is a sectional diagram showing the electronic device in FIG. 1B taken along line 1C-1C;

FIG. 2A is a schematic diagram showing that the first body is pushed to slide along the direction shown by an arrow;

FIG. 2B is sectional diagram showing the electronic device in FIG. 2A taken along line 2B-2B;

FIG. 3A is a schematic diagram showing that the first body is pushed to be located; and

FIG. 3B is a sectional diagram showing the electronic device in FIG. 3A taken along line 3A-3A.

### DETAILED DESCRIPTION OF THE EMBODIMENTS

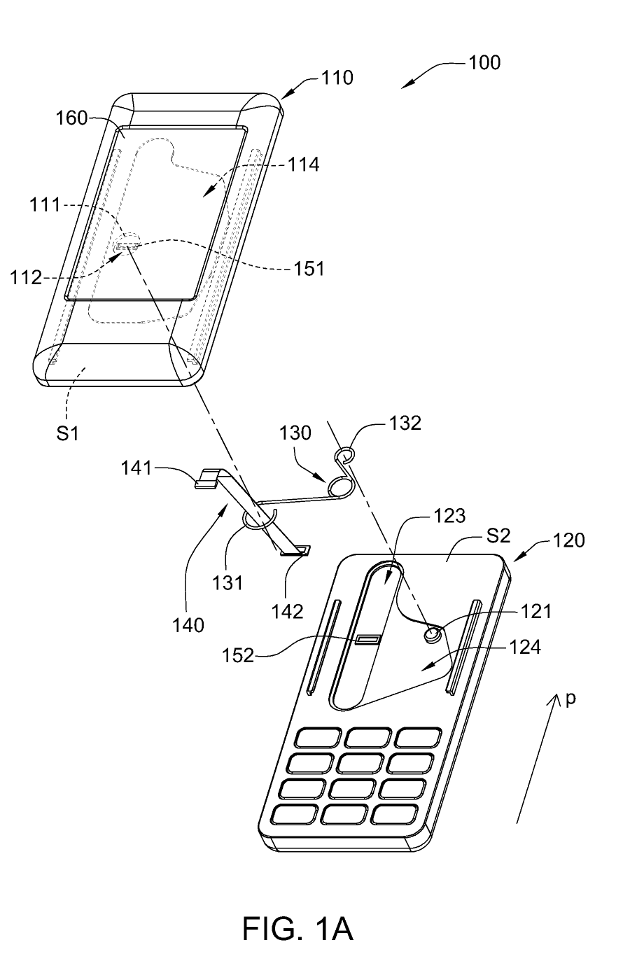

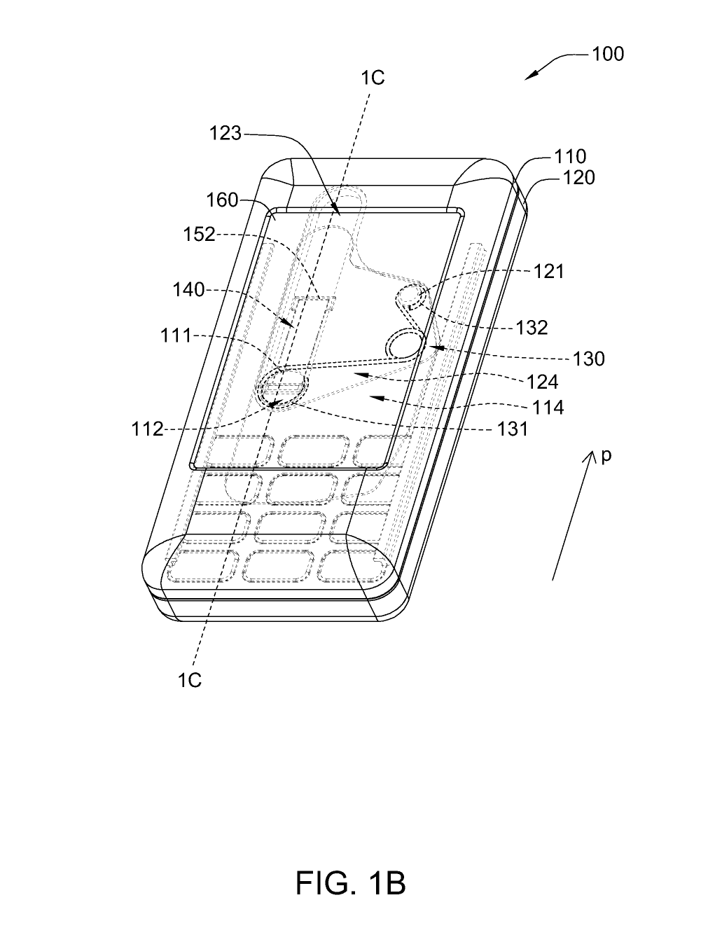

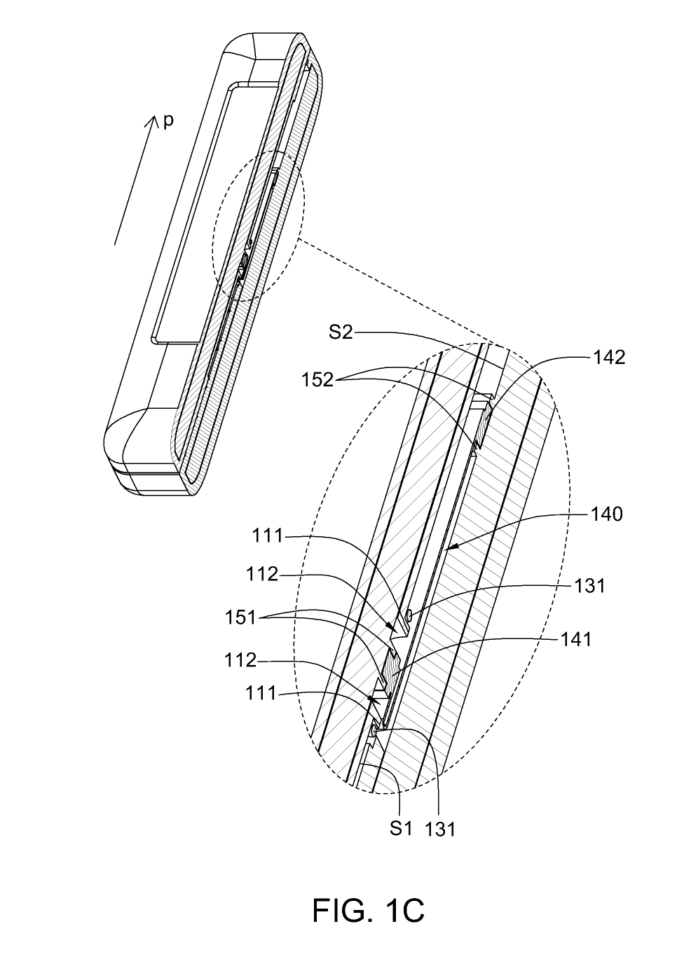

FIG. 1A is an exploded diagram showing the electronic device according to a preferable embodiment of the invention. FIG. 1B is an assembly diagram showing the electronic device in FIG. 1A. FIG. 1C is a sectional diagram showing the electronic device in FIG. 1B taken along line 1C-1C.

As shown in FIG. 1A, FIG. 1B and FIG. 1C, the electronic device 100 is, for example, a mobile phone or a personal digital assistant (PDA), and it includes a first body 110, a second body 120, an elastic component 130, a flexible cable 140, a first connecting port 151, a second connecting port 152 and a display panel 160.

The first surface S1 of the first body 110 is opposite to the second surface S2 of the second body 120. The first body 110 may slide straight along the direction of a sliding path p relative to the second body 120. In the embodiment, the display panel 160 is disposed at the first body 110. However, the position of the display panel 160 is not limited thereto, and the display panel 160 also may be disposed at the second body 120.

In the embodiment, the elastic component 130 is located between the first body 110 and the second body 120. The first body 110 has a first protrusion 111 and a hole which penetrates the first protrusion 111 at the first surface S1. The second body 120 has a second protrusion 121 at the second surface S2. The elastic component 130 has a first fixing portion 131 and a second fixing portion 132. The first fixing portion 131 is, for example, a retaining ring, and it is sleeved and fixed on the second protrusion 121.

In the embodiment, the elastic component 130 is a bent torsion spring, and as a person skilled in the art knows, the shape of the elastic component 130 is not specially limited. In addition, the mode in which the first fixing portion 131 of the elastic component 130 is fixed to the first protrusion 111 and the mode in which the second fixing portion 132 is fixed to the second body 120 are also not limited.

The mode in which the display panel 160 of the first body 110 and the second body 120 are electrically coupled to each other is illustrated herein. The first connecting port 151 of the electronic device 100 is disposed in the hole 112 of the first body 110 and electrically coupled to the display panel 160. The second connecting port 152 is disposed in a groove 123 of the second body 120. A first connecting end 141 of the flexible cable 140 used to transmit data or signals is connected to the first connecting port 151 in the hole 112, and a second connecting end 142 of the flexible cable 140 is connected to the second connecting port 152. Thus, the signals and the data which need be transmitted between the display panel 160 of the first body 110 and the second body 120 are transmitted by the flexible cable 140. Other elements of the first body 110 and the second body 120 also may be electrically connected in the above mode to transmit signals.

Preferably, to reduce the thickness of the electronic device 100 to meet the requirement of the user, the first body 110 has a recess 14 at the first surface S1. Besides the groove 123, the second body 120 further has a recess 124 at the second surface S2.

The consideration in designing the recesses 114 and 124 are illustrated herein. The first fixing portion 131 of the elastic component 130 is fixed on the first protrusion 111 of the first body 110. When the first body 110 moves, the first fixing portion 131 moves along with the first protrusion 111 to make the elastic component 130 deformed. Considering the whole size of the electronic device 100, the recesses 114 and 124 are located at the first surface S1 of the first body 110 and the second surface S2 of the second body 120, respectively. The shapes of the recesses 114 and 124 are designed, for example, to fit the moving path and the deformation shape of the elastic component 130 to accommodate an elastic component 130. Thus, regardless of whether the elastic component 130 moves, it can be accommodated in the recesses 114 and 124 to reduce the whole size of the electronic device effectively.

The design of the groove 123 is illustrated herein. When the first body 110 slides, the first fixing portion 131 fixed at the first protrusion 111 and the first connecting end 141 of the flexible cable 140 in the hole 112 are driven to move by the first protrusion 111. Considering the whole thickness of the electronic device 100, the groove 123 is substantially located at the second body 120 along the direction parallel with the sliding path p. The groove 123 is on the moving path of the first protrusion 111 and the flexible cable 140 to accommodate the first protrusion 111 and the flexible cable 140. Therefore, regardless of whether the positions of the first protrusion 111 and the flexible cable 140 are changed due to the sliding of the first body 110, both the first protrusion 111 and the flexible cable 140 may be accommodated in the groove 123 to reduce the thickness of the electronic device 100 effectively. As shown in FIG. 1C, the flexible cable 140 may be folded and disposed in the groove 123.

In the embodiment, the position of the first connecting port 151 is corresponding to that of the groove 123. In addition, the position of the second connecting port is in the groove 123. Since the groove 123 is substantially disposed in the second body 120 along the direction parallel with the sliding path p, when the first body 110 slides along the direction of the sliding path p relative to the second body 120, the flexible cable 140 may slide straight in the groove 123. In addition, since the connecting end 141 of the flexible cable 140 is connected to the first connecting port 151 in the hole 112, when the first body 110 moves relative to the second body 120, the connecting end 141 is protected by the first protrusion 111, and it is not easy to be improperly drawn due to the movement of the elastic component 130. Thus, compared with the condition that the cable is easy to be improperly drawn or tangled when the bodies move in the conventional technique, the moving mode of the flexible cable 140 in the embodiment is easy, and it also may avoid being damaged by improper drawing and abrading. The groove and the recesses may be disposed selectively, and it is not limited in the invention. For example, an assembly clearance may exist between the first body and the second body to accommodate the elastic component and the flexible cable. In another embodiment, each of the two bodies of the electronic device has a recess to accommodate the elastic component. The flexible cable is disposed in the assembly clearance of the first body and the second body.

The moving mode of the elements in the electronic device 100 when the first body 110 slides straight along the sliding path p relative to the second body 120 is illustrated herein.

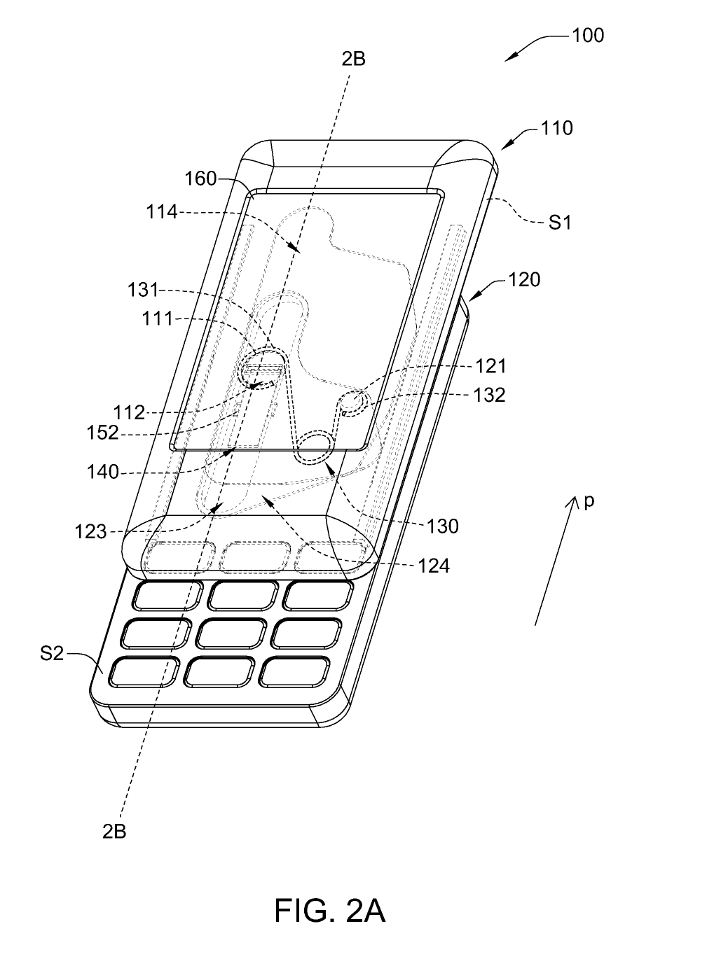

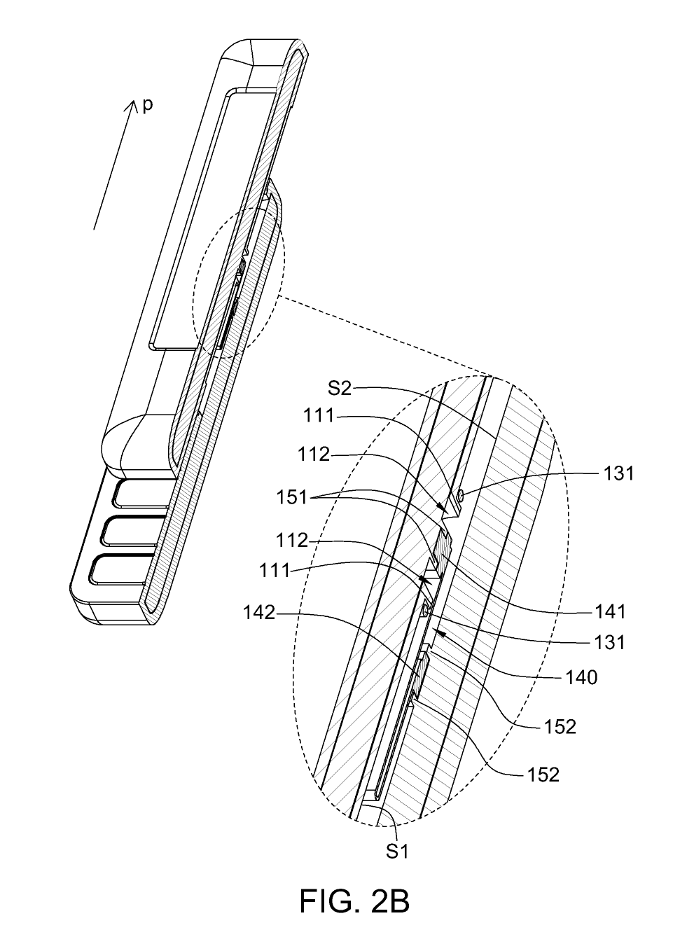

As shown in FIG. 2A and FIG. 2B, when a user pushes the first body 110 along the direction of the sliding path p shown by an arrow, the first protrusion 111 of the first body 110 moves along with the first body 110. The first fixing portion 131 fixed on the first protrusion 111 and the first connecting end 141 of the flexible cable 140 in the hole 112 move along with the first body 110 in the groove 123. Since the second fixing portion 132 of the elastic component 130 is fixed to the second protrusion 112 of the second body 120, when the second body 120 does not move, and the first fixing portion 131 gets close to the second fixing portion 132 along the direction of the sliding path p shown by an arrow (as shown in FIG. 2A), the elastic component 130 may deform, and relative elastic potential energy is generated.

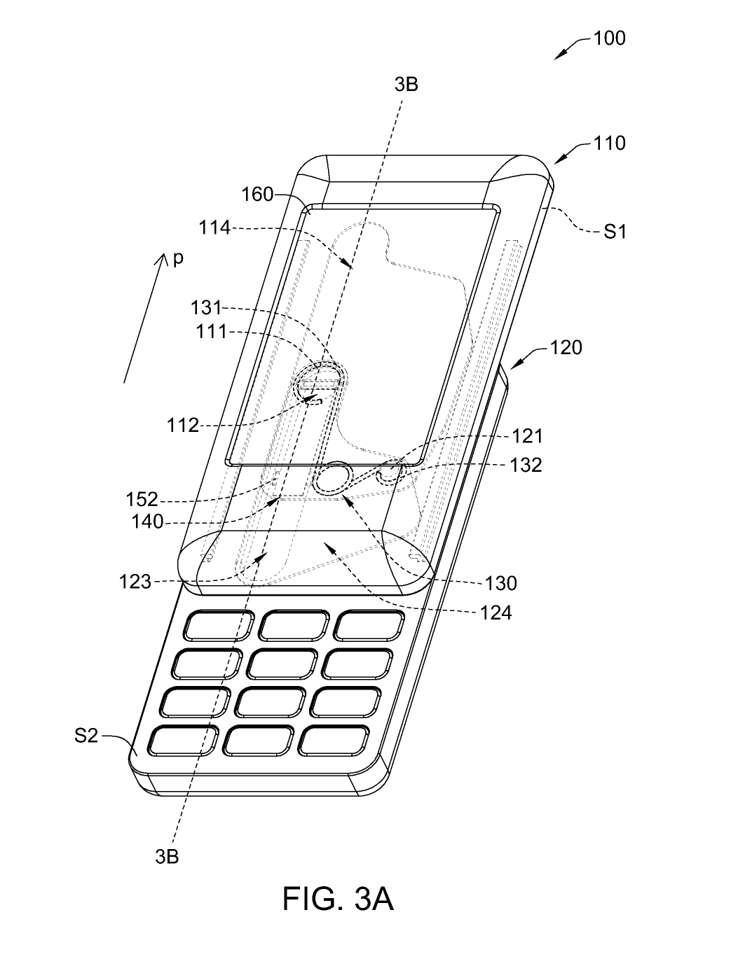

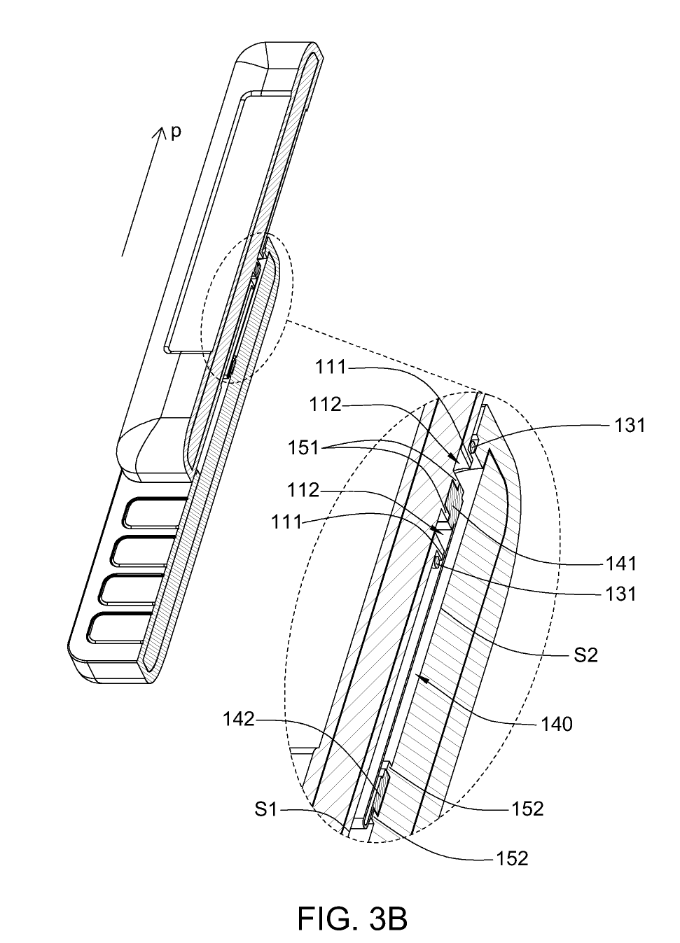

In the embodiment, whether the elastic potential energy generated by the elastic component 130 may transform to be kinetic energy toward the direction of the sliding path p shown by an arrow is determined by the position of the first fixing portion 131. Before the first fixing portion 131 of the elastic component 130 passes a critical position (such as the position of the first fixing portion 131 in FIG. 2A), the kinetic energy of the elastic component 130 gained by the first body 110 may make the first body 110 move along the direction opposite to the direction of the sliding path p shown by the arrow. After the critical position is passed, during the process of moving the elastic component 130 from the state in FIG. 1B to the state in FIG. 2A, the potential energy is generated. The potential energy may make the first body 110 move along the direction opposite to the direction of the sliding path p shown by the arrow. That is, the state of the first body 110 in FIG. 2A may be change to the state in FIG. 3A.

When the first fixing portion 131 of the elastic component 130 in FIG. 2A and FIG. 2B passes the critical position, even though the user does not push the first body 110 along the direction of the sliding path p shown by the arrow, the first body 110 still can slide towards the direction along the direction of the sliding path p shown by the arrow by the kinetic energy provided by the elastic component 130.

As shown in FIG. 3A and FIG. 3B, when the first body 110 slides towards the direction along the direction of the sliding path p shown by the arrow by the kinetic energy provide by the elastic component 130, and the first protrusion 111 is limited by an end of the groove 123 to be unable to move, the first body 110 is located. Thus, the user may operate the element disposed in the second body 120 such as the keys to operate the electronic device 110. The first body 110 may slide along the direction of the sliding path in the opposite direction in the same mode (that is the direction opposite to the direction of the sliding path p shown by the arrow) to go back to the position shown in FIG. 1B, and it is not illustrated again for a concise purpose.

In the electronic device disclosed in the embodiment of the invention, the flexible cable is set via the hole of the first body, and the flexible cable moves straight to make it uneasy to be broken due to improper drawing. Thus, compared with the electronic device in which bodies are driven to slide by using multiple spring leaves and compression springs, the number of the elements used to drive the body to slide in the electronic device of the embodiment is small, and the configuration mode of the elements is simple. Thus, the quality of the electronic device is improved, and the lifespan is prolonged.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. An electronic device comprising:
a first body having a first protrusion and a hole penetrating the first protrusion;
a second body connected to the first body along a sliding path;
an elastic component disposed between the first body and the second body and having a first fixing portion and a second fixing portion, wherein the first fixing portion is fixed on the first protrusion, and the second fixing portion is fixed at the surface of the second body towards the first body; and
a flexible cable located between the first body and the second body and having a first connecting end and a second connecting end, wherein the first connecting end passes through the hole and is electrically connected to the first body, and the second connecting end is electrically connected to the second body.

2. The electronic device according to claim 1, wherein the surface of the second body towards the first body has a groove, and the groove is substantially disposed at the second body along the direction parallel to the sliding path.

3. The electronic device according to claim 2 further comprising:
a first connecting port disposed in the hole of the first body, wherein the first connecting end of the flexible cable is connected to the first connecting port; and
a second connecting port disposed in the groove of the second body, wherein the second connecting end of the flexible cable is connected to the second connecting port.

4. The electronic device according to claim 1 further comprising:
a display panel disposed at the first body or the second body, when the display panel is disposed at the first body, the display panel is electrically coupled to the first connecting end of the flexible cable to be further electrically coupled to the second body, and when the display panel is disposed in the second body, the display panel is electrically coupled to the second connecting end of the flexible cable to be further electrically coupled to the first body.

5. The electronic device according to claim 1, wherein the surface of the first body towards the second body further has a recess.

6. The electronic device according to claim 1, wherein the surface of the second body towards the first body has a recess to accommodate the elastic component.

7. The electronic device according to claim 1, wherein the first fixing portion and the second fixing portion of the elastic component are retaining rings, and a second protrusion is disposed at the surface of the second body towards the first body, and the second fixing portion of the elastic component is fixed on the second protrusion.
